(19) United States
(12) Patent Application Publication
(10) Pub. No.: US 2017/0084142 A1
(43) Pub. Date: Mar. 23, 2017

(54) APPARATUS AND METHODS FOR GUIDING RESCUERS IN BURNING STRUCTURES

(71) Applicant: Michael A. Husson, (US)

(72) Inventors: Michael A. Husson, Worcester, MA (US); Nicolas Estecha-Milossevich, Shrewsbury, MA (US)

(21) Appl. No.: 15/095,989

(22) Filed: Apr. 11, 2016

Related U.S. Application Data
(63) Continuation-in-part of application No. 14/862,277, filed on Sep. 23, 2015, now abandoned.

(51) Int. Cl. G08B 7/06; G08B 17/10

(52) U.S. Cl. CPC G08B 7/06; G08B 17/10

(57) ABSTRACT

Aspects of the invention are directed to an apparatus for use in conjunction with a smoke detector, where the smoke detector produces a sound alarm upon activation. The apparatus includes a light display with a plurality of light sources, and detection circuitry. The detection circuitry is operative to detect the sound alarm from the smoke detector and to activate the light display in response to the sound alarm. When placed appropriately, signaling apparatus in accordance with aspects of the invention provide the ability to guide firefighters and other rescuers to rooms where occupants are more likely to be found.

### FIELD OF THE INVENTION

The present invention relates generally to alarm systems, and, more particularly, to signaling systems that aid rescuers in finding occupants in burning structures.

### BACKGROUND OF THE INVENTION

One of the primary tasks of a firefighter when arriving at a burning structure is to search that structure for occupants, and, if possible, rescue those occupants. Such a search requires that a firefighter enter a building with an unknown layout and proceed from room to room. Because of fire and smoke, the firefighter is frequently reduced to moving on hands and knees, and in some extreme cases, feeling his way about the building with little visibility.

Two factors conspire to make the work of a rescuing firefighter even harder and less likely to be successful. First, a firefighter may not know anything about the number and type of people that are likely to be in the structure. Such information is important because, while adult occupants will often try to aid in their rescue, young occupants will frequently attempt to hide from the danger (e.g., under a bed), thereby requiring more extensive searches where children are likely to be present. At the same time, because a firefighter is most often unfamiliar with the layout of the burning structure, that firefighter has little ability to prioritize the searching of rooms, and often wastes precious time searching rooms where an occupant is unlikely to be found. Late at night, for example, it is much more probable that an occupant will be in a bedroom rather than in, for example, a living room, office, or bathroom. But without knowing what room is what, a firefighter must essentially search the rooms in the structure based on the sequence in which the rooms are encountered.

There is, as a result, the need for apparatus that address the above-identified factors that conspire against a firefighter while searching a burning structure for occupants, and, in so doing, make the firefighter's rescue efforts more likely to be successful.

### SUMMARY OF THE INVENTION

Embodiments of the present invention address the above-identified needs by providing signaling apparatus that, when activated, help to lead rescuers to rooms in burning structures that are likely to be occupied.

Aspects of the invention are directed to an apparatus for use in conjunction with a smoke detector, the smoke detector producing a sound alarm upon activation. The apparatus comprises a light display including a plurality of light sources, and detection circuitry. The detection circuitry is operative to detect the sound alarm and to activate the light display in response thereto.

Additional aspects of the invention are directed to a structure comprising a smoke detector and a signaling apparatus. The smoke detector is operative to produce a sound alarm upon activation. The signaling apparatus comprises a light display including a plurality of light sources, and detection circuitry. The detection circuitry is operative to detect the sound alarm and to activate the light display in response thereto.

Even additional aspects of the invention are directed to a method of preparing a structure in case of fire. A smoke detector is placed in the structure, the smoke detector operative to produce a sound alarm upon activation. A signaling apparatus is also placed in the structure. The signaling apparatus comprises a light display including a plurality of light sources, and detection circuitry. The detection circuitry is operative to detect the sound alarm and to activate the light display in response thereto.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of a signaling apparatus in accordance with an illustrative embodiment of the invention, with the signaling apparatus mounted to a doorframe in a burning building and actively signaling a firefighter;

FIG. 2 shows a block diagram of the FIG. 1 signaling apparatus and its relationship to a smoke detector;

FIG. 3 shows a block diagram providing further details of the FIG. 1 signaling apparatus;

FIG. 4 shows an electrical schematic of various components in the FIG. 1 signaling apparatus;

FIG. 5 shows a flow diagram of a program sequence to be run by a microcontroller in the FIG. 1 signaling apparatus;

FIG. 6 shows a flow diagram of another program sequence to be run by the microcontroller in the FIG. 1 apparatus;

FIG. 7A shows a front perspective view of the FIG. 1 signaling apparatus mounted to a doorframe;

FIG. 7B shows an exploded perspective view of the FIG. 1 signaling apparatus and the doorframe;

FIG. 8A shows a front perspective view of an alternative signaling apparatus in accordance with a second illustrative embodiment of the invention;

FIG. 8B shows a rear perspective view of a portion of the FIG. 8A alternative signaling apparatus and a suction-cup mounting hook; and

FIG. 9 shows a perspective view of the FIG. 8A alternative signaling apparatus mounted in a window of a burning building.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

As used in the present specification and the appended claims, the term “proximate” means within a distance of one foot (0.3 meters). Moreover, a “smoke detector” is intended to cover any form of alarm that can detect the presence of smoke, heat, and/or fire, and that produces a sound alarm when activated. A “smoke detector” as used herein therefore encompasses many forms of fire alarms.

Aspects of the invention are directed to a signaling apparatus that may be placed near the entrance of a room in a house, particularly those rooms occupied by children or disabled persons. The signaling apparatus includes detection circuitry operative to detect the sound alarm from a conventional smoke detector, and to activate a light display and generate a separate sound alarm in response thereto. When so activated, the signaling apparatus signals a firefighter that he should search the associated room for occupants first and with sufficient thoroughness.

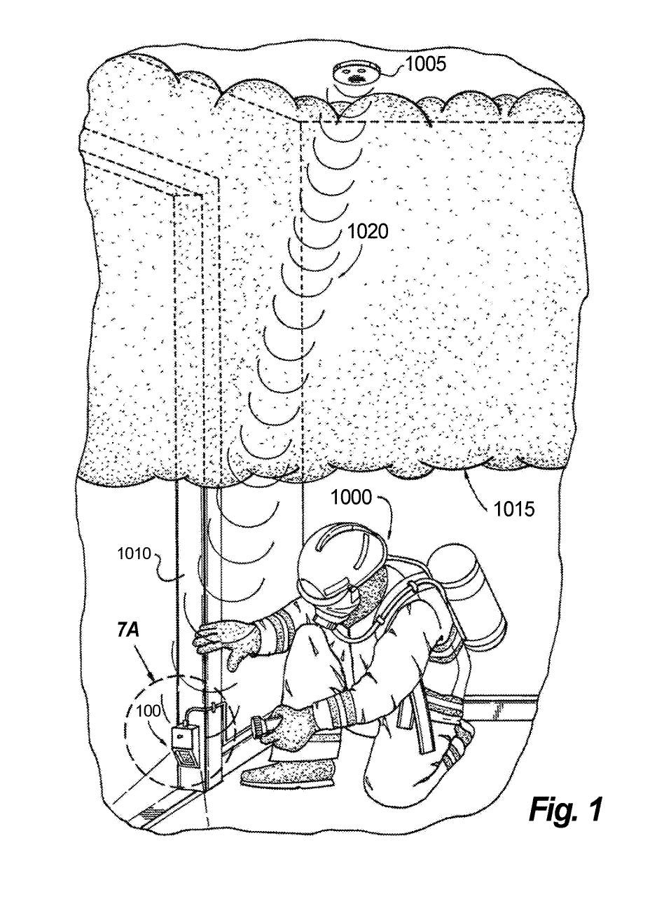

FIG. 1 shows a perspective view of such a signaling apparatus 100 as it might appear when activated in a home that is on fire and while actively signaling a firefighter 1000 as to the likely presence of an occupant. In the illustrated situation, a smoke detector 1005 is mounted to the ceiling of a structure, while the signaling apparatus 100 is mounted near the bottom of an interior doorframe 1010 within sound range of the smoke detector 1005. The smoke detector 1005 has activated in response to smoke 1015, and is producing a sound alarm 1020. The signaling apparatus 100 has detected this sound alarm 1020, and has activated a light display and is generating its own sound alarm in response thereto. In this manner, the signaling apparatus 100 has successfully attracted the attention of the firefighter 1000.

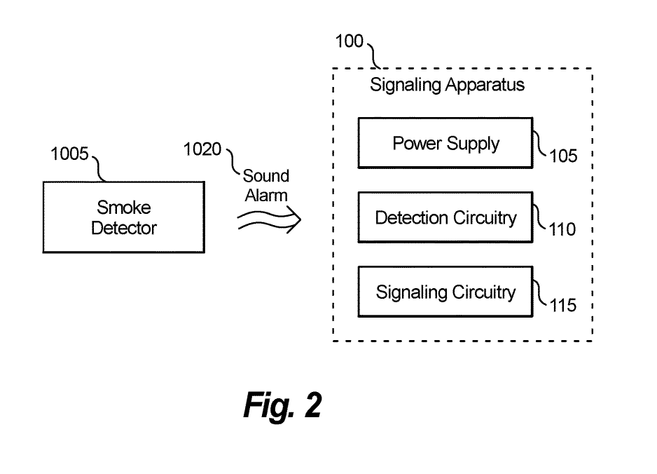

FIG. 2 shows a block diagram that further elucidates the relationship between the signaling apparatus 100 and the smoke detector 1005, as well as indicates additional aspects of the signaling apparatus 100 itself. The signaling apparatus 100 can be broken down into three sub-systems: a power supply 105; detection circuitry 110; and signaling circuitry 115. As its name would suggest, the power supply 105 supplies power to the signaling apparatus 100. The detection circuitry 110 listens for the sound alarm 1020 produced by the smoke detector 1005, and when detected, activates the signaling circuitry 115. Finally, the signaling circuitry 115, comprising lights and a sound generator, acts to call attention to the signaling apparatus 100 and, in so doing, to lead firefighters or other rescuers to the unit.

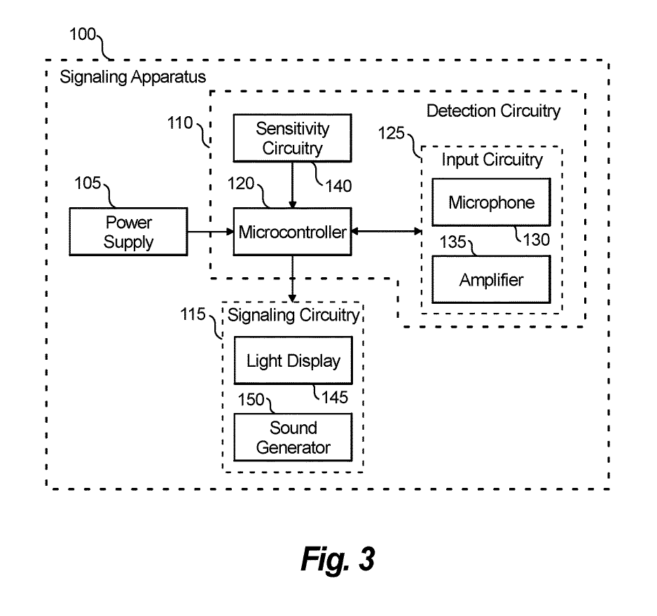

The power supply 105, the detection circuitry 110, and the signaling circuitry 115 are even further broken down in the block diagram in FIG. 3. In the present illustrative, non-limiting embodiment, the detection circuitry 110 comprises a microcontroller 120, input circuitry 125 with a microphone 130 and an amplifier 135, and sensitivity circuitry 140. The signaling circuitry 115 includes a light display 145 (including a plurality of light sources) and a sound generator 150. To fulfill the detection function of the detection circuitry 110, the signaling apparatus 100 is configured such that the microcontroller 120 receives signals from (and provides power to) the microphone 130 and the amplifier 135, and utilizes those amplified microphone signals in conjunction with a sensitivity setting provided by the sensitivity circuitry 140 to determine if the microphone 130 is receiving sound frequencies characteristic of a smoke detector. If the microcontroller 120 determines that, in fact, a smoke detector is sounding a sound alarm, it activates the light display 145 and the sound generator 150 in the signaling circuitry 115.

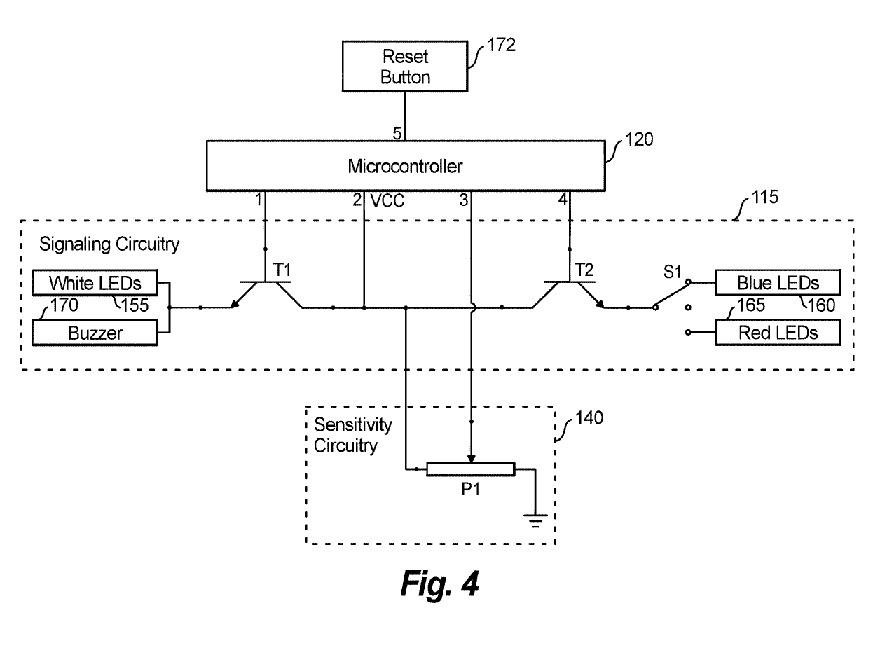

More specific wiring with respect to the microcontroller 120, the sensitivity circuitry 140, and the signaling circuitry 115 is shown in schematic form in FIG. 4. Five input/output pins (labeled 1-5 in the figure) are shown for the microcontroller 120, although it would be expected that, in actual reduction to practice, the microcontroller 120 would have many more pins, including those required to receive the inputs from the power supply 105, and from the microphone 130 and the amplifier 135. At the same time, the pin numbers in FIG. 4 are not in any way intended to represent the actual pin assignments on an actual microcontroller.

Before proceeding further in describing FIG. 4, it is noted that, solely for simplicity of presentation, the schematic in FIG. 4 does not show the presence of resistors, which may be present in the circuitry in order to tune the voltages going to the various elements. Nevertheless, the implementation of such resistors in the present embodiment will be familiar to one having ordinary skill in the relevant electronics arts given the teachings that are provided.

The microcontroller 120 may be a small computer on a single integrated circuit (system-on-chip (SOC)) containing a processor core (i.e., data processor), memory, and programmable input/output peripherals. Program memory in the form of, for example, random access memory (RAM), flash memory, and/or read-only memory (ROM) may also be included on the chip to allow the microcontroller to be programmed to execute coded instructions. Additional memory may also be present for maintaining data during the actual processing.

Pins 2-4 of the microcontroller 120 are in signal communication with elements of the signaling circuitry 115, thereby allowing the microcontroller 120 to activate the signaling circuitry 115, as set forth above. In the present illustrative embodiment, the signaling circuitry 115 comprises a first transistor T1, a second transistor T2, a user-accessible three-way switch S1, a set of white light-emitting diodes (LEDs) 155, a set of blue LEDs 160, a set of red LEDs 165, and a buzzer 170. In this manner, the set of white LEDs 155, the set of blue LEDs 160, and the set of red LEDs 165 form part of the aforementioned light display 145, while the buzzer 170 forms part of the aforementioned sound generator 150. Pin 1 of the microcontroller 120 is wired to the base of the first transistor T1, while pin 4 is wired to the base of the second transistor T2. Pin 2 of the microcontroller 120 provides a positive supply voltage (VCC) to a respective collector on each of the transistors T1, T2. The emitter of the first transistor T1 is connected to the set of white LEDs 155 and the buzzer 170. Finally, the emitter of the second transistor T2 is wired to the three-way switch S1, which, based on its position, effectively connects that emitter to the set of blue LEDs 160, the set of red LEDs 165, or neither set.

So configured, the microcontroller 120 may, when acting to activate the set of white LEDs 155 and the buzzer 170, set pin 1 HIGH, and thereby turn on transistor T1. When acting to activate whatever is selected by the three-way switch S1, the microcontroller 120 can simply set pin 4 HIGH.

The sensitivity circuitry 140 provides a sensitivity voltage to the microcontroller 120, which, after being converted into an integer sensitivity value, is utilized by the microcontroller 120 to decide when it is detecting a sound alarm provided by a smoke detector. Aspects of this conversion are discussed below. In the present illustrative embodiment, the sensitivity circuitry 140 comprises a potentiometer P1 that is adjustable via a user-accessible sensitivity knob. Pin 2 of the microcontroller provides VCC to the input of the potentiometer P1, while the ground of the potentiometer P1 is grounded. Pin 3 of the microcontroller 120 is wired to the output of the potentiometer P1, and effectively allows the microcontroller 120 to read the sensitivity voltage setting of the potentiometer P1.

A reset button 172 is connected to pin 5 of the microcontroller 120. When the reset button 172 is pressed, pin 5 is grounded and the microcontroller 120 responds by restarting any algorithms that are presently running. If the microcontroller 120 is presently commanding the signaling circuitry 115 to activate one or more of the sets of LEDs 155, 160, 165 and the buzzer 170, pressing the reset button 172 has the effect of stopping these commands and turning off the signaling circuitry 115 until a sound alarm is re-detected by the detection circuitry 110.

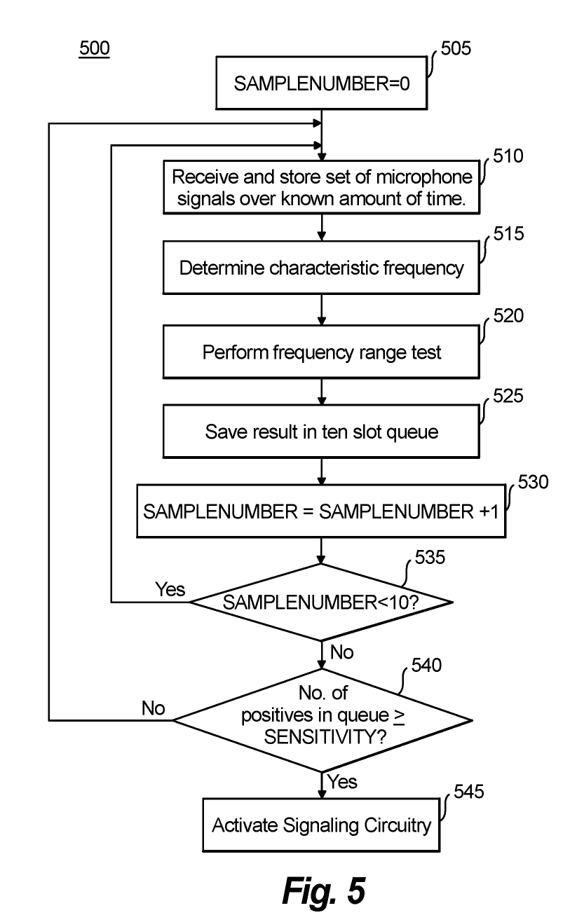

FIG. 5 shows a flow diagram that describes a program sequence 500 (i.e., method steps) to be executed by the microcontroller 120, in accordance with an illustrative embodiment of the invention. The program sequence 500 allows the microcontroller 120 to perform both its detection role as part of the detection circuitry 110, as well as its role in commanding the activation of the signaling circuitry 115 when a sound alarm is detected.

Step 505 in the program sequence 500 sets the variable SAMPLENUMBER equal to zero. Next, in step 510, the microcontroller 120 receives a set of analog input signals (voltages) from the microphone 130 and the amplifier 135 over a known amount of time, and stores those signals in a one-dimensional array (i.e., a list). In so doing, the analog input voltages from the microphone 130 and the amplifier 135 are mapped to integer sound values by the microcontroller 120. In one or more embodiments, for example, a 10-bit analog-to-digital converter within the microcontroller 120 may map zero-to-five-volt analog input signals to integer values between 0 and 1023. In one or more embodiments, moreover, the microcontroller 120 may accumulate about 190 integer sound values from the input circuitry 125 over two milliseconds. All of these particular values, however, are only by way of illustration and may vary widely based on settings and a specific microcontroller's specifications.

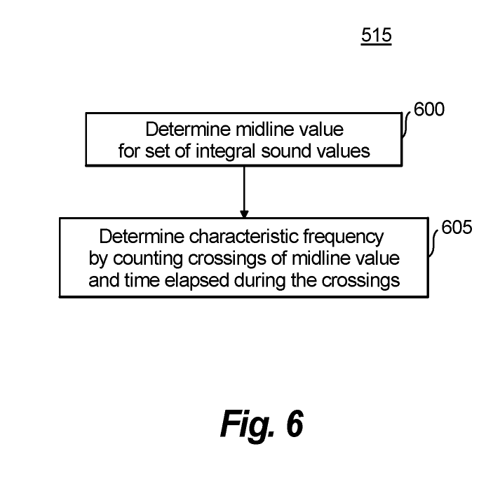

Subsequently, in step 515, the microcontroller 120 analyzes the list of integer sound values obtained in step 510 and determines a characteristic frequency for those integer sound values. Such a step may be accomplished in several different ways. FIG. 6 shows one such method for performing step 515, in accordance with an illustrative embodiment of the invention.

Now referring to FIG. 6, step 600 has the microcontroller 120 work through the list of integer sound values captured in step 510, and determine a minimum value and a maximum value. Those two values are then utilized to calculate a midline value half-way between the minimum value and the maximum value.

Subsequently, in step 605, the microcontroller 120 sequentially goes through the list of integer signal values and counts the number of times those signal values cross the midline value determined in step 600 (CROSSINGS). The microcontroller 120 further determines the time elapsed between the first time the integer sound values cross the midline value and the last sound measurement in the integer sound value list (SAMPLE TIME). With this information, the characteristic frequency is calculated based on the following formula: CHARACTERISTIC FREQUENCY=CROSSINGS/(2×SAMPLE TIME).

Now referring back to the flow chart in FIG. 5, step 520 of the program sequence 500 has the microcontroller 120 determine whether the characteristic frequency determined in step 515 falls within one or more frequency ranges characteristic of sound alarms from smoke detectors. This test is hereinafter referred to as a “frequency-range test.” Two frequency ranges that may be utilized are, for example, 3030-3330 Hertz (Hz) and 500-540 Hz. The results of the frequency-range test are then stored in a ten-slot queue in step 525. This queue sequentially maintains ten results. Once the tenth slot is filled, the addition of a new result causes the earliest result remaining in the queue to be discarded. The queue is therefore a first-in, first out (FIFO) data structure.

In step 530, SAMPLENUMBER is incremented by one. In step 535, the microcontroller 120 determines whether SAMPLENUMBER is less than ten. In effect, the microcontroller 120 is determining whether, by this step in the process, ten separate sets of integer sound values have been received (step 510) and processed (steps 515-525). If the answer is affirmative (i.e., less than ten sets), then the program sequence 500 returns to step 510 and another set is collected and analyzed. If, instead, ten sets have in fact been collected, the program sequence 500 proceeds to step 540.

The decision in step 540 has the microcontroller 120 determine whether the number of positive results in the queue is greater than or equal to SENSITIVITY. In the present illustrative embodiment, SENSITIVITY is simply an integer between one and ten proportional to the sensitivity voltage setting measured at pin 3 of the microcontroller 120, which is connected to the the output of the potentiometer P1 (FIG. 4). Given that the setting on the potentiometer P1 is user-adjustable via a user-accessible sensitivity knob, SENSITIVITY is likewise user-adjustable. Accordingly, the decision in step 540 is a determination by the microcontroller 120 whether the number of sets of integer sound values from the input circuitry 125 deemed to have characteristic frequencies indicative of a smoke detector over the last ten such sets collected is higher than a user-adjustable sensitivity number between one and ten (represented by SENSITIVITY).

If the decision in step 540 is negative, the process returns to step 510 and an additional set of signals is collected from the detection circuitry 125. In contrast, if the decision in step 540 is affirmative, the program sequence 500 proceeds to step 545, where the microcontroller 120 activates the signaling circuitry 115. In step 545, the microcontroller 120 may, for example, set pins 1 and 4 HIGH, thereby opening transistors T1 and T2, and activating some combination of the set of white LEDs 155, the buzzer 170, the set of blue LEDs 160, and the set of red LEDs 165. If desired, the microcontroller 120 may be programmed to periodically switch between HIGH and LOW on one or both of pins 1 and 4 (e.g., every second), effectively making the corresponding sets of LEDs 155, 160, 165 and the buzzer 170 blink or pulse.

Given the above, one will recognize that a user, through control of the potentiometer P1 and, by extension, through control of SENSITIVITY, has control of the sensitivity of the signaling apparatus 100 to a sound alarm produced by a smoke detector. If a user sets SENSITIVITY lower, fewer sets of integer sound values from the input circuitry 125 out of ten need to have characteristic frequencies falling within the ranges of a smoke detector to cause the microcontroller 120 to activate the signaling circuitry 115. If a user sets SENSITIVITY higher, a greater number of these sets out of ten need to have a characteristic frequency falling within these ranges. A user will therefore ideally experiment with the user-accessible sensitivity knob on the potentiometer P1 so as to avoid false alarms, while, at the same time, not setting the sensitivity knob so high as to miss real sound alarms.

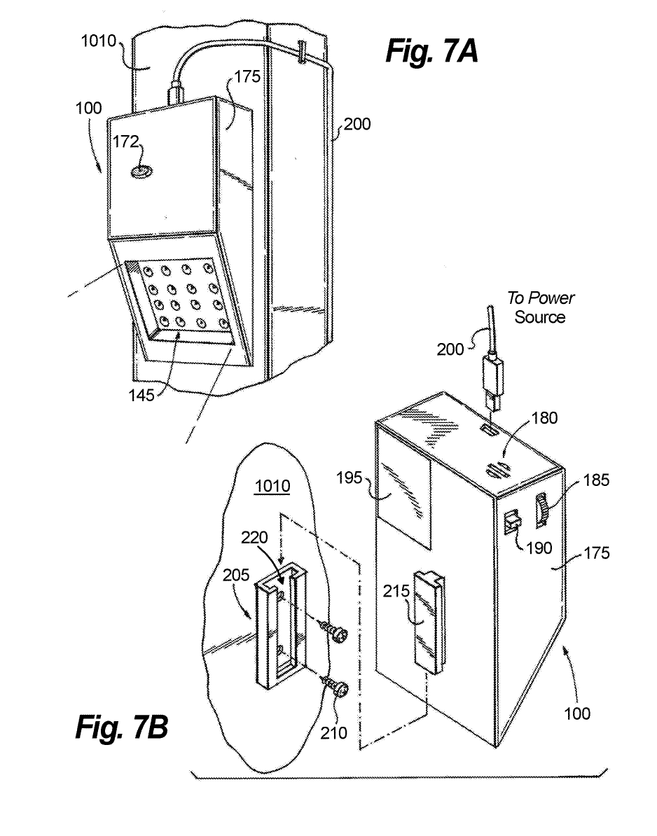

The physical form of the signaling apparatus 100 is shown in a front perspective view in FIG. 7A with the signaling apparatus 100 attached to the doorframe 1010, while an exploded rear perspective view of the same elements is shown in FIG. 7B. The signaling apparatus 100 comprises a box 175 with a sloped, recessed, frontal region that contains and presents the light display 145. The reset button 172 is visible on the front of the box 175, while openings 180 for the microphone 130 are visible on the top of the box 175. A side of the box 175 contains a user-accessible sensitivity knob 185 attached to the potentiometer P1, as well as a tab 190 for the three-way switch 51.

The signaling apparatus 100 is powered by a rechargeable battery that resides in a battery compartment covered by a battery cover 195, visible on the rear of the box 175. In the present embodiment, the power supply 105 thereby comprises a rechargeable battery. To keep the rechargeable battery charged, the signaling apparatus 100 is connected to wall power via a detachable power cord 200. The signaling apparatus 100 also comprises a mounting piece 205 that is screwed into the doorframe 1010 by two screws 210, and a complementary extension 215 attached to the back of the box 175. The mounting piece 205 defines a receiving slot 220, into which the extension 215 is removably insertable. The signaling apparatus 100 may therefore be quickly attached to, and quickly detached from, the doorframe 1010, allowing a person to transport the signaling apparatus 100 with him or her, as desired. Such detachability may be of particular advantage if a user wishes to use the activated signaling device 100 as a source of light in an emergency.

As indicated above with reference to FIG. 4, the switch 51 allows a user to select whether the set of blue LEDs 160, the set of red LEDs 165, or neither set is lit when the signaling apparatus 100 is activated. When placing the signaling apparatus 100, for example, it may be advantageous to place switch S1 so that the set of red LEDs 165 are activated when a child is in the room serviced by the doorframe 1010, and to place switch S1 so that the set of blue LEDs 160 are activated when a disabled person is in the room serviced by the doorframe 1010. It is contemplated that firefighters could be educated as to what these different light colors (i.e., red versus blue) mean if and when signaling apparatus in accordance with aspects of the invention achieve widespread usage. As indicated above, these sets of LEDs 160, 165 may also be made to blink. Accordingly, in one illustrative configuration where a child is likely to be in the adjoining room, the signaling apparatus 100 could be configured such that the set of white LEDs 155 is on continuously and the set of red LEDs 165 flash when the signaling apparatus 100 is activated.

The box 175 forming the signaling apparatus 100 may be formed of plastic and may be produced by conventional plastic forming techniques such as injection molding, thermoforming, blow molding, rotational molding, and the like. The remaining components of the signaling apparatus 100 may largely be obtained off-the-shelf. In one or more embodiments, for example, the microcontroller 120 may comprise an ATtiny85 microcontroller available from ATMEL® Corp. (San Jose, Calif., USA) built onto a Trinket microcontroller board available from ADAFRUIT® Industries, LLC (New York, N.Y., USA). The microphone 130 may comprise a CMA-4544PF-W electret microphone available from CUI INC® (Tualatin, Oreg., USA), and the amplifier 135 may comprise a MAX4466 microphone amplifier available from MAXIM® Integrated Products (Sunnyvale, Calif., USA). With respect to software, once the program sequence 500 allowing the microcontroller 120 to perform its detection and command functions is understood from the teachings herein, the programming of a microcontroller 120 to perform such functions will be well within the skill of one having ordinary skill in the relevant programming arts. Programming microcontrollers is also described in many readily available publications, including, for example, S. F. Barrett et al., Atmel Avr Microcontroller Primer: Programming and Interfacing, Second Edition, Morgan & Claypool Publishers, 2012, which is hereby incorporated by reference herein.

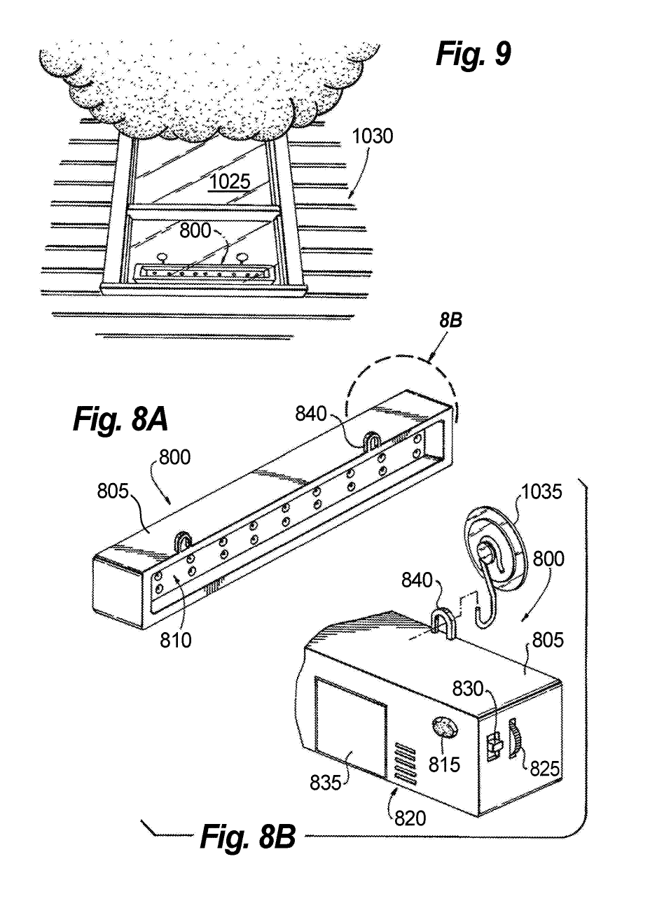

FIG. 8A shows a perspective view of an alternative signaling apparatus 800, in accordance with a second illustrative embodiment of the invention, while FIG. 8B shows a rear perspective view of a portion of the alternative signaling apparatus 800. While, externally, the alternative signaling apparatus 800 looks somewhat different from the signaling apparatus 100, the alternative signaling apparatus 800 comprises largely the same elements and functions in largely the same manner as the signaling apparatus 100. That is, the alternative signaling apparatus 800 contains all the electrical elements indicated in FIGS. 2-4 and may function using the same program sequence 500 set forth in FIGS. 5 and 6.

Likewise, on the outside, the alternative signaling device 800 comprises many elements analogous to those found on the signaling apparatus 100, namely: a box 805, a visible light display 810, a reset button 815, openings 820 for a microphone, a user-accessible sensitivity knob 825, a tab 830 for a three-way switch, and a battery cover 835 covering a compartment holding a rechargeable battery.

Unlike the signaling apparatus 100, however, the alternative signaling device is ideal for mounting in a window of a structure so that the light display 810 is visible to rescuers outside the structure. FIG. 9 shows a perspective view of the alternative signaling apparatus 800 mounted in a window 1025 of a burning structure 1030. The alternative signaling apparatus 800 is mounted utilizing two suction-cup mounting hooks 1035, a representative one of which is shown in FIG. 8B, which engage complementary loops 840 built onto the box 805 of the alternative signaling apparatus 800. So mounted, a rescuer positioned outside the structure will see the activated alternative signaling apparatus 800 in the window 1025, and will immediately recognize that an occupant is likely to be found in the room behind the window 1025. Given this knowledge, the firefighter will be motivated to access that room as soon as possible.

It will be quickly recognized from the teachings herein, that the signaling apparatus 100, 800, and, more generally, signaling apparatus falling within the scope of the invention, have the potential to save lives by allowing rescuers to focus on rooms of burning structures where occupants are more likely to be found. The ability to vary the light color provided by these signaling apparatus, moreover, provides the opportunity to signal a rescuer that an occupant is likely to be a child or disabled, thereby communicating to the rescuer that the associated room needs to be searched with the thoroughness appropriate to these classes of occupants. In all cases, the signaling apparatus rely on the sound alarms from conventional smoke detectors for their activation. This allows the signaling apparatus to be inexpensively manufactured, and also allows them to be mounted low in a structure (e.g., at the bottom of a doorframe) where smoke and heat, which both rise, are less likely to collect. Thus, the signaling apparatus may be mounted where the visibility in a fire tends to be better, and the temperature lower. The corresponding smoke detector, on the other hand, may remain high in the structure so that it is more likely to be exposed to smoke when a fire occurs.

While the above-described embodiments have focused on signaling apparatus, methods of preparing a structure in case of fire would also fall within the scope of the invention. In such methods, for example, a smoke detector may be placed in a structure, with the smoke detector operative to produce a sound alarm upon activation. A signaling apparatus is then also placed in the structure. The signaling apparatus includes a light display comprising a plurality of light sources. Detection circuitry in the signaling apparatus is operative to detect the sound alarm generated by the smoke detector and to activate the light display in response thereto.

In closing, it should again be emphasized that the above-described embodiments of the invention are intended to be illustrative only. Other embodiments can use different types and arrangements of elements for implementing the described functionality. For example, it is recognized that alternative signaling apparatus falling within the scope of the invention may have very different physical forms from the illustrative embodiments set forth above. At the same time, in alternative embodiments, aspects implemented in software (e.g., via a program sequence implemented on a data processor) may be implemented in hardware, and vice versa. These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in AIA 35 U.S.C. §112(f). In particular, the use of “steps of” in the claims herein is not intended to invoke the provisions of AIA 35 U.S.C. §112(f).

What is claimed is:

1. An apparatus for use in conjunction with a smoke detector, the smoke detector producing a sound alarm upon activation, and the apparatus comprising:
a light display comprising a plurality of light sources; and
detection circuitry operative to detect the sound alarm and to activate the light display in response thereto.

2. The apparatus of claim 1, further comprising a battery operative to power the detection circuitry and the light display.

3. The apparatus of claim 1, wherein the detection circuitry comprises:
a microcontroller; and
a microphone in signal communication with the microcontroller.

4. The apparatus of claim 3, further comprising an amplifier, wherein the microphone is in signal communication with the microcontroller through the amplifier.

5. The apparatus of claim 3, wherein the microcontroller is programmed to determine a frequency of signals from the microphone, and to determine whether the frequency is within one or more frequency ranges characteristic of the sound alarm.

6. The apparatus of claim 3, wherein:
the microcontroller is programmed to, for each of a pre-determined number of time segments, determine a frequency of signals from the microphone, and to determine whether the frequency is within one or more frequency ranges characteristic of the sound alarm; and
the microcontroller is further programmed to activate the light display if the frequency is within one or more frequency ranges characteristic of the sound alarm for a user-determined number of the pre-determined number of time segments.

7. The apparatus of claim 6, further comprising a user-settable potentiometer in signal communication with the microcontroller, wherein the user-determined number is determined by the microcontroller at least in part by a setting on the user-settable potentiometer.

8. The apparatus of claim 3, wherein the light display comprises a transistor controlled by the microcontroller and configured to switch at least some of power going to the plurality of light sources when the detection circuitry activates the light display.

9. The apparatus of claim 1, wherein the plurality of light sources comprise a plurality of light-emitting diodes.

10. The apparatus of claim 1, wherein the plurality of light sources comprise two light sources with different colors.

11. The apparatus of claim 1, wherein at least some of the plurality of light sources flash when the detection circuitry activates the light display.

12. The apparatus of claim 1, further comprising a user-settable switch configured to determine which of the plurality of light sources are activated by the detection circuitry when the detection circuitry activates the light display.

13. The apparatus of claim 1, further comprising a sound generator, wherein the detection circuitry is further operative to activate the sound generator in response to detection of the sound alarm.

14. The apparatus of claim 13, wherein the sound generator comprises a buzzer.

15. The apparatus of claim 1, further comprising a reset button operative to interrupt an activation of the light display when pressed.

16. The apparatus of claim 1, further comprising:
a mounting piece defining a receiving slot;
a box containing the light display and the detection circuitry; and
an extension attached to the box and removably insertable into the receiving slot.

17. A structure comprising:
a smoke detector operative to produce a sound alarm upon activation;
a signaling apparatus comprising:
a light display comprising a plurality of light sources; and
detection circuitry operative to detect the sound alarm and to activate the light display in response thereto.

18. The structure of claim 17, wherein the structure comprises a door, and the signaling apparatus is positioned proximate to the door.

19. The structure of claim 17, wherein the structure comprises a window, and the signaling apparatus is positioned inside the structure proximate to the window with the the light display oriented towards the window.

20. A method of preparing a structure in case of fire, the method comprising the steps of:
placing a smoke detector in the structure operative to produce a sound alarm upon activation;
placing a signaling apparatus in the structure, the signaling apparatus comprising:
a light display comprising a plurality of light sources; and
detection circuitry operative to detect the sound alarm and to activate the light display in response thereto.
